(19) United States
(12) Patent Application Publication
(10) Pub. No.: US 2017/0053322 A1
(43) Pub. Date: Feb. 23, 2017

(54) MAKING AND ADJUSTING ADVERTISER BIDS BASED ON CALL CENTER OCCUPANCY

(71) Applicant: GOOGLE INC., Mountain View, CA (US)

(72) Inventors: Nandan Dixit, Mountain View, CA (US); Amit Agarwal, Sunnyvale, CA (US); Suman Gundapaneni, Sunnyvale, CA (US); Tao Huang, Sunnyvale, CA (US); Gaurav Bhaya, Sunnyvale, CA (US)

(21) Appl. No.: 14/830,709

(22) Filed: Aug. 19, 2015

(51) Int. Cl. G06Q 30/02; H04M 3/51

(52) U.S. Cl. CPC G06Q 30/0275; H04M 3/5183

(57) ABSTRACT

An advertising system receives an advertisement from a merchant system and receives data from a call center associated with the merchant system and with the advertisement. The advertising system determines a call center occupancy at the merchant system call center. The advertising system determines a first bid for an advertising space auction based on the call center occupancy and transmits the first bid to an advertising platform hosting the advertising space auction. The advertising system receives a notice of progress of the advertising space auction from the advertising platform system. If the advertising space auction is still open, the advertising system determines the current call center capacity and adjusts the first bid for the auction based on the current call center capacity. The advertisement is displayed on a user computing device. When a user selects the advertisement, the user computing device dials the merchant system call center.

### TECHNICAL FIELD

The present disclosure relates generally to improving the electronic bidding process for electronic auctions for electronic advertising spaces.

### BACKGROUND

Advertisers maximize the value of advertising by efficiently selecting advertising spaces that effectively produce conversions. Certain advertisements displayed on websites, when selected by users via user computing devices, may transmit instructions to user computing devices to initiate phone calls by the respective user computing devices to a call center associated with a merchant system associated with the advertisement. Users calling a call center may be more likely to purchase a service or a product when they are promptly connected to sales agents or customer service agents at call centers. For example, users may be less likely to purchase a product or continue a service if they must wait on hold for a long time to be connected to a sales agent or customer service agent at a call center.

### SUMMARY

Techniques herein provide computer-implemented methods to adjust bids for electronic advertising spaces based on call center occupancy. In an example embodiment, an advertising system receives, from a merchant system, an advertisement. The merchant system registers a call center associated with the merchant system and the advertisement with the advertising system. For example, the merchant system grants the advertising system access to live data associated with the call center. The advertising system monitors the call center occupancy at the merchant system call center. The advertising system determines a first bid for an advertising space auction and transmits the first bid to an advertising platform hosting the advertising space auction. The advertising system receives a notice of progress of the advertising space auction from the advertising platform system. If the advertising space auction is still open, the advertising system adjusts the first bid for the auction based on the current call center capacity. The advertising space auction may receive a second notice of progress of the advertising space auction from the advertising platform system. If the advertising space auction is closed, the advertising system transmits a notice to the merchant system that the auction is closed. The advertisement is displayed on a user computing device at an appropriate time. For example, the user logs into a website associated with the advertising platform and views the advertisement on the website. The user selects the advertisement and the user computing device dials the merchant system call center in response to the user selecting the advertisement.

In certain other example aspects described herein, systems and computer program products to adjust bids for electronic advertising spaces based on call center occupancy are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for adjusting bids for advertising spaces based on merchant system call center occupancy, in accordance with certain example embodiments.

FIG. 2 is a block flow diagram depicting a method for adjusting bids for advertising spaces based on merchant system call center occupancy, in accordance with certain example embodiments.

FIG. 3 is a block flow diagram depicting a method for monitoring call center occupancy at a merchant system call center, in accordance with certain example embodiments.

FIG. 4 is a block flow diagram depicting a method for determining, by an advertising system, an initial bid for an advertising space auction, in accordance with certain example embodiments.

FIG. 5 is a block flow diagram depicting a method for adjusting, by an advertising system, a bid for an advertising space auction based on merchant system call center occupancy, in accordance with certain example embodiments.

FIG. 6 is a block diagram depicting a computing machine and module, in accordance with certain example embodiments.

### DETAILED DESCRIPTION OF EXAMPLE EMBODIMENTS

### Overview

The example embodiments described herein provide computer-implemented techniques for adjusting bids for advertising spaces based on merchant system call center occupancy.

In an example embodiment, an advertising system receives, from a merchant system, an advertisement. The merchant system registers a call center associated with the merchant system and the advertisement with the advertising system. For example, the merchant system grants the advertising system access to live data associated with the call center. The advertising system monitors the call center occupancy at the merchant system call center. The advertising system determines a first bid for an advertising space auction and transmits the first bid to an advertising platform hosting the advertising space auction. The advertising system receives a notice of progress of the advertising space auction from the advertising platform system. If the advertising space auction is still open, the advertising system adjusts the first bid for the auction based on the current call center capacity. The advertising space auction may receive a second notice of progress of the advertising space auction from the advertising platform system. If the advertising space auction is closed, the advertising system transmits a notice to the merchant system that the auction is closed. The advertisement is displayed on a user computing device at an appropriate time. For example, the user logs into a website associated with the advertising platform and views the advertisement on the website. The user selects the advertisement and the user computing device dials the merchant system call center in response to the user selecting the advertisement. In another example, the advertisement displays a telephone number associated with the merchant system call center and the user inputs the telephone number into the user computing device and instructs the user computing device to dial the telephone number.

An advertising system receives an advertisement from a merchant system. For example, the merchant system designs or otherwise generates an advertisement and transmits the advertisement to the advertising system. An example advertisement comprises an advertisement that may be displayed on a website or web-based application accessible via a user computing device over a network. The example advertisement comprises an advertisement, that when selected by a user via a user computing device, causes the user computing device to call a call center associated with the merchant system. The example advertisement may conform to standards set by an advertising system or an advertising platform system. For example, the standards may comprise a predetermined display size, a predetermined file size, or a predetermined duration (for video or audio advertisements). A merchant system may transmit a plurality of advertisements to the advertising system.

In certain example embodiments, in addition to transmitting the advertisement to the advertisement system, the merchant system allocates funds for the advertising system. For example, the merchant system enters into an agreement with the advertising system for the advertising system to provide advertising services for merchant system. In this example, the merchant system allocates a certain amount of funds for the advertising system to spend over a predetermined time period. For example, the advertising system may spend the allocated funds on advertisement space with one or more advertising platforms, such as websites, television, radio, or paper advertisements. In an example embodiment, the advertising system bids for advertisement space with one or platforms against other advertising systems or merchant systems in advertisement space auctions. For example, multiple merchants and/or advertising systems bid for a 24 hour ad space on a website.

In certain example embodiments, in addition to transmitting the advertisement to the merchant system, the merchant system defines bidding parameters. For example, the merchant system defines a low bidding threshold, a high bidding threshold, and acceptable bidding intervals according to call center occupancy. For example, the merchant system may define $1.00 as a low bidding threshold for a 24 hour advertising space on a website and $100.00 as the high bidding threshold. In this example, the merchant system may define $1.00 as an acceptable bid when the merchant system call center occupancy is at 100% and $100.00 as an acceptable bid when the merchant system call center occupancy is at 0%. In this example, the merchant system may instruct the advertising system to increase the bid for the advertising space by $1.00 for each decrease in call center occupancy of 1% and decrease the bid for the advertising space by $1.00 for each increase in the call center occupancy of 1%. For example, if the current bid was $40.00 in an advertising space auction and the call center occupancy decreased by 5%, the bidding parameters may instruct the advertising to increase the bid by $5.00 to $45.00 for the advertising space. The advertising system receives the merchant system bidding preferences. In an example embodiment, the merchant system bidding preferences comprise the allocated funds and the bidding parameters.

The advertising system monitors call center occupancy at a merchant system call center. The call center is a call center associated with the merchant system that is dialed when a user selects an advertisement displayed on a user computing device. The merchant system registers the call center with the advertising system and grants the advertising system access to call center data. The advertising system receives the call center data or monitors the call center data. The advertising system determines the call center capacity. For example, the call center capacity may comprise the maximum number of calls that may be accepted by the call center at the current time. The call center capacity may vary depending on the time of the day, day of the week, day of the month, season of the year, or month of the year. The call center data received from the advertising system may comprise the call center capacity. In another example, the call center data comprises the call center capacity comprising a number of current merchant system agents currently able to answer telephone calls at the call center. The advertising system determines a current call center volume. For example, call center volume comprises the current number of telephone calls in progress at the call center. The advertising system determines a current average hold time at the call center. For example, the advertising system determines the current average length of time for a call to the call center to be answered by an agent at the call center. The advertising system determines a current call center occupancy for the call center. In an example, the current call center occupancy is the current call center volume divided by the current call center capacity. In another example, the current call center occupancy is based on the current average hold time.

The advertising system determines an initial bid for an advertising space auction. In an example embodiment, the advertising platform transmits notice of an advertising space auction to the advertising system. In an example embodiment, the advertising platform is separate from the advertising system. In another example embodiment, the advertising system comprises or is associated with the advertising platform system. For example, the advertising system maintains a website advertising platform comprising advertising space for which the advertising system hosts advertising space auctions. An example advertising space auction comprises an auction for an advertising space comprising a web page or web-based application. In this example, the advertising space auction is for an advertising space that is able to host the advertisement transmitted by the merchant system to the advertising system. The advertising system receives the notice of the advertising space auction and determines the current merchant call center occupancy. The advertising system determines an initial bid for the advertising space auction based on the current call center occupancy and transmits the initial bid to the advertising platform system.

The advertising system receives a notification of a progress of the advertising space auction from the advertising platform system and determines whether the advertising space auction is closed or still open. If the advertising system determines that the auction is closed, the advertising system transmits a notice to the merchant system that the auction is closed. For example, receiving a notification of progress of the auction comprising a notice of a closed auction comprises receiving a notification that the advertising system won the auction for the advertising space or that the advertising system lost the auction for the advertising space. In this example, the notice that the auction is closed transmitted by the advertising system to the merchant system may further comprise notification that the advertising system won the advertising space in the advertising space auction for the advertisement or did not win the advertising space for the advertisement in the advertising space auction.

If the advertising system determines that the advertising space auction is open, the advertising system adjusts the first bid for the auction based on current call center capacity. For example, the advertising system determines a current call center capacity and determines a second (or subsequent) bid based on the current call center capacity. If the second or subsequent bid is not different from the first (or previous) bid for the advertising space auction, the advertising system does not submit the second or subsequent bid for the advertising space to the advertising platform system. If the second or subsequent bid is different from the first or previous bid for the advertising space, the advertising system submits the second or subsequent bid to the advertising space platform for the advertising space auction. At a later time, the advertising system receives a subsequent notification of progress of the advertising space auction.

If the advertising system receives a notification from the advertising platform system that the advertising space auction is closed, whether after a first bid or after a subsequent bid, the advertising system determines that the auction is closed based on the received notification and transmits a notice to the merchant system that the auction is closed. In an example embodiment, the advertising system transmits notice to the merchant system that the advertising system won the advertising space auction. In another example embodiment, the advertising system transmits notice to the merchant system that the advertising system did not win the advertising space auction. The advertisement is displayed on a user computing device. For example, the advertisement is displayed on a website of the advertising platform according to the terms of the advertising space auction. In this example, a user accesses the website via a user computing device and selects the displayed advertisement via the user computing device. In this example, upon receiving an input of a selection of the advertisement via the user interface by the user, the user computing device initiates a telephone call via the user computing device to the call center as instructed by the advertisement operating on the user computing device. In an example, the user's call via the user computing device is answered by an agent working at the call center, and the agent provides customer service to the user or invites the user to purchase a product associated with the advertisement.

By using and relying on the methods and systems described herein, the advertising system determines bids for electronic advertising space auctions on behalf of the merchant system based on merchant system call center occupancy. By determining and making bids on behalf of the merchant system to the advertising platform, the advertising system eliminates or reduces any interaction between computing devices associated with the merchant system and the advertising platform. Additionally, by giving the advertising system access to call center data, interactions between merchant system and the advertising system are minimized. For example, in certain embodiments, the methods and systems described herein do not require the merchant system to actively submit call center data since the advertising system has periodic or continual access to the call center data. As such, the systems and methods described herein may reduce the inputs required and the processing required by the merchant system. Additionally, the systems and methods described herein may improve the efficiency of merchant system advertising. For example, by decreasing the bid for advertising spaces as call center occupancy increases, the advertising system economizes the advertising resources of the merchant system since advertising conversion is less as call center occupancy increases.

### Example System Architecture

Turning now to the drawings, in which like numerals indicate like (but not necessarily identical) elements throughout the figures, example embodiments are described in detail.

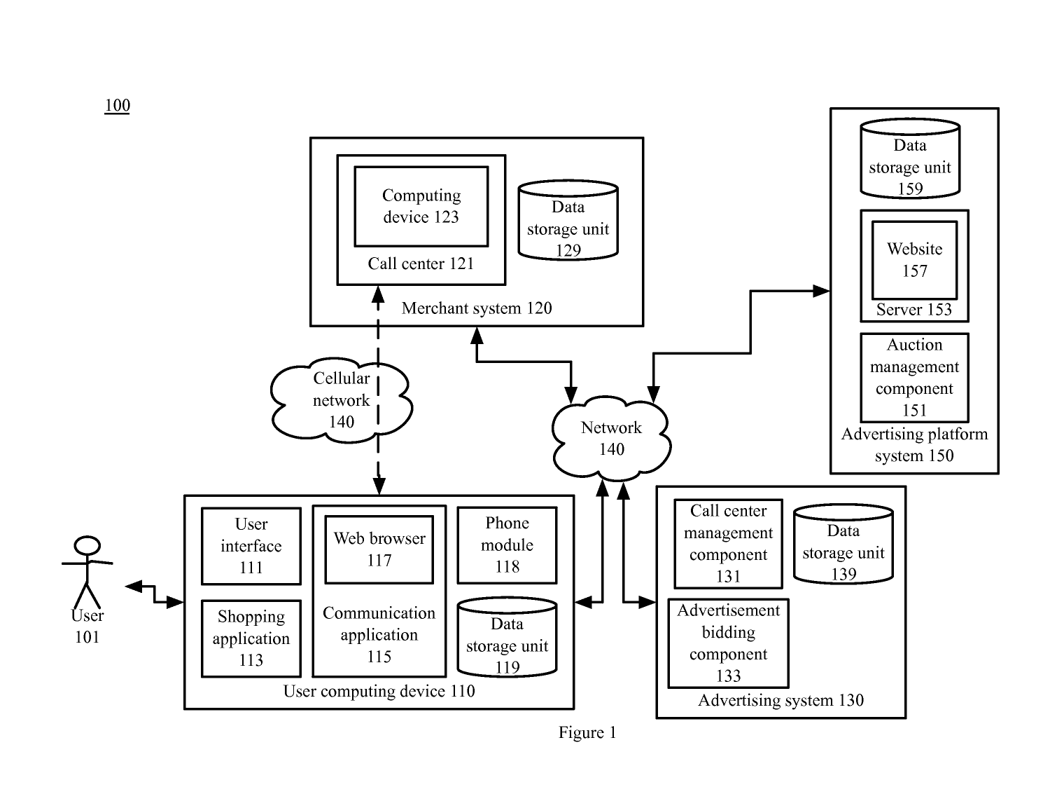

FIG. 1 is a block diagram depicting a system 100 for adjusting bids for advertising spaces based on merchant system 120 call center 121 occupancy, in accordance with certain example embodiments. As depicted in FIG. 1, the system 100 includes network computing devices 110, 120, 130, and 160 that are configured to communicate with one another via one or more networks 140. In some embodiments, a user associated with a device must install an application and/or make a feature selection to obtain the benefits of the techniques described herein.

In example embodiments, the network 140 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, Bluetooth low energy, NFC, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110, 120, 130, and 150 includes a device having a communication module capable of transmitting and receiving data over the network 140. For example, each network computing device 110, 120, 130, and 150 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network computing devices 110, 120, 121, 130, and 150 are operated by users 101, merchant system 120 operators, call center 121 operators, advertising system 130 operators, and advertising platform system 150 operators, respectively.

An example user computing device 110 comprises a user interface 111, a shopping application 113, a communication application 115, a web browser 117, a phone module 118, and a data storage unit 119.

In an example embodiment, the user interface 111 may comprise a touch screen, a voice-based interface or any other interface that allows the user 101 to provide input and receive output from an application or module on the user computing device 110. In an example embodiment, the user interface 111 enables the user 101 to interact with the shopping application 113 or a web browser 117. For example, the user 101 may interact, via the user interface 111, with the shopping application 113 or the web browser 117 to access an advertising platform system website 157 and view an advertisement associated with the merchant system 120. In an example embodiment, the user 101 selects the advertisement displayed on the website 157 via the user interface 111.

In an example embodiment, the shopping application 113 is a program, function, routine, applet, or similar entity that exists on and performs its operations on the user computing device 110. In certain embodiments, the user 101 must install the shopping application 113 and/or make a feature selection on the user computing device 110 to obtain the benefits of the techniques described herein. In an example embodiment, the shopping application 113 communicates with the advertising platform system website 157 and/or other available websites via the network 150. In this example embodiment, the user 101 downloads the shopping application 113 to the user computing device 110. In an example embodiment, the user 101 may view and/or interact with the website 157 via the shopping application 113. In another example embodiment, the user 101 accesses a web browser 117 application associated with the merchant system 120 to view and/or interact with the website 157. In an example embodiment, the user 101 may view a merchant system 120 advertisement displayed on the website 157 via the shopping application 113, for example, an advertisement displayed in an advertising space on the website 157 that the merchant system 120 won in an advertising space auction hosted by the advertising platform system 150.

In an example embodiment, the user 101 can use a communication application 115, such as a web browser 117 application or a stand-alone application (such as the shopping application 113), to view, download, upload, or otherwise access documents or web pages via a distributed network 140.

In an example embodiment, the web browser 117 can enable the user 101 to interact with web pages using the user computing device 110. In an example embodiment, the user 101 may access the advertising platform system website 157 the web browser 117. In an example embodiment, the user 101 may view a merchant system 120 advertisement displayed on the website 157 via the web browser 117, for example, an advertisement displayed in an advertising space on the website 157 that the merchant system 120 won in an advertising space auction hosted by the advertising platform system 150.

In an example embodiment, the phone module 118 comprises a component of the user computing device 110 that controls a calling functionality of the user computing device 110. In an example, the phone module 118 is part of the operating system of the user computing device 110. In another example, the phone module 118 comprises an application resident on the user computing device 110. In an example embodiment, the phone module 118 communicates with the shopping application 113 and/or the web browser 117. In an example embodiment, when a user 101 selects, via the user computing device user interface 111, an advertisement of the website 157 of the advertising platform system 150, the phone module 118 receives instructions from the web browser 117 or the shopping application 113 to initiate a telephone call with a call center 121 associated with the merchant system 120 associated with the advertisement.

In an example embodiment, the data storage unit 119 comprises a local or remote data storage structure accessible to the user computing device 110 suitable for storing information. In an example embodiment, the data storage unit 119 stores encrypted information, such as HTML5 local storage.

In certain example embodiments, one or more functions herein described as performed by the shopping application 113 may also be performed by a web browser 117 application, for example, a web browser 117 application associated with a merchant system 120, an advertising system 130, or an advertising platform system 150. In certain example embodiments, one or more functions herein described as performed by shopping application 113 and/or a web browser 117 application may also be performed by the user computing device 110 operating system. In certain example embodiments, one or more functions herein described as performed via the web browser 117 may also be performed via the shopping application 113.

An example merchant system 120 comprises a data storage unit 129 and a call center 121, which comprises a computing device 123. In an example embodiment, the merchant system 120 creates or otherwise generates advertisements and utilizes an advertising system 130 to bid for advertising spaces with one or more advertising platform systems 150. In an example embodiment, the merchant system 120 transmits bidding preferences to the advertising system 130 via the network 150.

In an example embodiment, the call center 121 comprises a physical location where one or more sales agents and/or customer service agents of the merchant system 130 are able to receive calls from users 101 or customers of the merchant system 120. In an example embodiment, the merchant system 120 grants access to data associated with the call center 121 to the advertising system 130. For example, the merchant system 120 may periodically or continuously transmit call center data, for example, via a computing device 123, via the network 140 to the advertising system 130. In another example embodiment, the merchant system 120 allows the advertising system 130 remote access to the computing device 123 of the call center 121 that enables the advertising system 130 to access live call center 121 data. Example call center 121 data comprises a number of agents currently able to answer calls at the call center 121, a number of agents currently engaged in a call, or other relevant data. Call center 121 data may also comprise call-specific data for each currently active call, for example, a hold time comprising a length of time for the agent to answer the call.

In an example embodiment, the computing device 123 communicates call center 121 data to the advertising system 130 via the network. For example, the computing device 123 periodically or continuously communicates current call center 121 data to the advertising system 130. In another example, the computing device 123 receives a request from the advertising system 130 over the network 140 and transmits current call center 121 data to the advertising system 130 in response to receiving the request. In yet another example, the computing device 123 is remotely accessible by advertising system 130 over the network 140 and the advertising system 130 remotely extracts call center 121 data from the call center 121 via the computing device 123. In an example embodiment, the call center 121 computing device 123 is communicatively coupled to a plurality of telephone devices at the call center 121 and may determine whether a particular telephone device is currently engaged in an active telephone call or not currently engaged in an active telephone call or monitor a status of one or more active calls at the call center 121. For example, the computing device 123 may determine, for each active call at the call center 121, the time it takes for an agent of the call center 121 to answer a telephone call after the call is received at the call center 121. The computing device 123 may also determine a current call center capacity comprising a current number of agents currently able to answer calls at the call center 121 and a current call center 121 volume comprising current number of agents currently engaged in telephone calls at the call center 121 based on data received from the plurality of telephone devices at the call center 121. In an example embodiment, the computing device 123 may determine a call center 121 occupancy based on the current call center 121 volume and current call center 121 capacity. In an example embodiment, the computing device 121 may transmit the current call center 121 capacity or otherwise allow access to the current call center 121 capacity to the advertising system 130. The computing device 123 may transmit additional call center 121 data in addition to or instead of the current call center 121 occupancy.

In an example embodiment, the data storage unit 129 comprises a local or remote data storage structure accessible to the merchant system 120 suitable for storing information. In an example embodiment, the data storage unit 129 stores encrypted information, such as HTML5 local storage.

An example advertising system 130 comprises a call center management component 131, an advertisement bidding component 133, and a data storage unit 139.

In an example embodiment, the call center management component 131 monitors merchant system call center 121 data. An example call center management component 131 comprises one or more computing devices able to communicate via a network 140 with the merchant system 120 and able to calculate a current call center 121 occupancy as described herein. In an example embodiment, the call center management component 131 communicates over the network 140 with the merchant system call center computing device 123 to receive and/or monitor current call center 121 data. In an example embodiment, the call center management component 131 periodically requests and receives, requests and continuously receives, and/or otherwise periodically or continually requests and receives call center 121 data from the merchant system 120 over the network 140. In another example embodiment, the call center management component 131 remotely accesses the merchant system call center computing device 123 to determine current call center 121 data. In an example embodiment, based on received and/or accessed call center 121 data, the call center management component 131 calculates a current call center 121 occupancy. In an example embodiment, the call center management component 131 communicates the calculated current call center 121 occupancy to the advertising bidding component 133 of the advertising system 130. In certain example embodiments, the call center management component 131 communicates a subsequent current call center 121 occupancy to the advertising bidding component 133. In an example embodiment, the call center management component 131 calculates an initial and/or subsequent current call center 121 capacity and transmits the respective call center 121 capacity to the advertising bidding component 133 in response to receiving a request for the current call center 121 capacity from the advertising bidding component 133.

In an example embodiment, the advertisement bidding component 133 determines bids for one or more advertising space auctions hosted by an advertising platform system 150, communicates bids to the advertising platform system 150, and/or receives notifications of progress of advertising space auctions from the advertising platform system 150. An example advertising bidding component 133 comprises one or more computing devices able to communicate with the merchant system 120 and the advertising platform system 150 via the network 140 and able to calculate bids for advertising space auctions. In certain example embodiments, the advertising bidding component 133 receives an advertisement and one or more bidding preferences from the merchant system 120 via the network 140. The advertising bidding component 133 may receive a current call center 121 occupancy from the call center management component 131, where the call center 121 is associated with the advertisement received from the merchant system 130. In another example, the advertising bidding component 133 may request a current call center 121 occupancy from the call center management component 131 and receive the current call center 121 occupancy from the call center management component 131 in response to the request, wherein the call center management component 131 determines the current call center 121 occupancy based on call center 121 data received from the merchant system 120. The advertising bidding component 133 may request the current call center 121 capacity from the call center management component 131 in response to receiving a notice of an advertising space auction from the advertising platform system 150 over the network 140. The advertising bidding component 133 may determine, after receiving a notice of an advertising space auction from the advertising platform system 150, an initial bid for the advertising space auction based on merchant system 120 bidding preferences and a current call center 121 occupancy. The advertising bidding component 133 may transmit the initial bid to the advertising platform system 150 for the advertising space auction. The initial bid may comprise the advertisement received from the merchant system 120 or the advertising bidding component 133 and/or the advertising system 130 may otherwise submit the advertisement to the advertising platform system 150 to associate with the auction.

At a time after submitting the initial bid, the advertising bidding component 133 may receive notification of a progress of the advertising space auction from the advertising platform system 150 via the network 140. An example notification of progress of the advertising space auction may comprise a notification that the auction is closed or a notification that the auction is still open. An example notification that the auction is closed further comprises a notification that the merchant system 120 won the advertising space auction or that an entity other than the merchant system 120 won the advertising space auction. In an example embodiment, in response to receiving a notification that the auction is open, the advertising bidding component 133 determines a subsequent bid for the advertising space auction. For example the advertising bidding component 133 requests a subsequent current call center 121 capacity from the call center management component 131, receives the subsequent current call center 121 capacity from the call center management component 131 in response to the request, and calculates the subsequent bid based on the subsequent current call center 121 capacity and the merchant system 120 bidding preferences.

In an example embodiment, if the subsequent bid is different from the initial bid, the advertising bidding component 133 transmits the subsequent bid to the advertising platform system 150 for the advertising space auction. In another example embodiment, if the subsequent bid is the same as the initial bid, the advertising bidding component waits for a subsequent notification of progress from the advertising platform system 150. In an example embodiment, the advertising bidding component 133 continues to receive notifications of progress of the advertising space auction from the advertising platform system 150 and to submit subsequent bids for the advertising space auction according to the method previously described. For example, as call center 121 occupancy changes over time while the advertising space auction is still open, the advertising bidding component 133 continues to submit subsequent bids if necessary until receiving notification that the auction is closed.

In an example embodiment, the data storage unit 139 comprises a local or remote data storage structure accessible to the advertising system 130 suitable for storing information. In an example embodiment, the data storage unit 139 stores encrypted information, such as HTML5 local storage.

An example advertising platform system 150 comprises an auction management component 151, a server 153, a website 157, and a data storage unit 159.

In certain example embodiments, the advertising platform system 150 comprises the server 153 and the website 157. In this example, the advertising platform system 150 auctions off an advertising space on the website 157 in one or more advertising space auctions in which the advertising system 130 may participate by placing bids on behalf of one or more merchant systems 120. In other example embodiments, the advertising platform system 150 does not comprise the server 153 and/or the website 157. In these example embodiments, the advertising platform system 150 may not run the server 153 and/or the website 157, but owns the rights to place advertisements on certain regions of the website 157 and conducts advertising space auctions to auction off the applicable regions of the website 157.

In an example embodiment, the auction management component 151 hosts, conducts, and/or otherwise manages one or more advertising space auctions. An example auction management component may comprise one or more computing devices able to receive bids for an advertising space auction via the network 140 from the advertising system 130, determine a status of an advertising space auction, and transmit a notification of a progress of an advertising space auction to the advertising system 130. In an example embodiment, the auction management component 151 identifies a free advertising space, for example, an advertising space on a website 157 of the advertising platform system 150. In this example embodiment, may determine specifications for the advertising space on the website 157. In this example embodiment, the auction management component 151 may announce the beginning of an advertising space auction by transmitting a notification of a new advertising space auction to one or more advertising systems 130 and/or merchant systems 120 in addition to the specifications for the advertising space on the website 157.

In an example advertising space auction, advertising systems 130 may transmit bids on behalf of merchant systems 120 and/or merchant systems 120 may transmit bids directly to the advertising platform system 150. In an example embodiment, the auction management component 151 receives one or more bids from the one or more advertising systems 130 and/or merchant systems 120 for the advertising space auction. In this example embodiment, the auction management component 151 may receive an advertisement for display in the advertising space along with the initial bid from the respective advertising system 130 or merchant system 120 making the bid. For example, the advertisement meets specifications predetermined by the advertising space auction. In an example embodiment, the auction management component 151 transmits a notification of a progress of the advertising space auctions to all parties that have made a bid in the auction. For example, if the advertising system 130 made at least one bid in the advertising space auction, the advertising system 130 would receive a notification of the progress of the auction from the advertising platform system 150. An example notification of progress generated by the auction management component 151 may comprise notification that the auction is closed and that a particular advertising system 130 or merchant system 120 won the auction or notification that the auction is still open. In an example embodiment, the auction management component 151 determines that an auction has ended according to predetermined rules of the auction and awards the advertising space to the winning bidder. In an example embodiment, the auction management component 151 communicates a request to the website 157 to display the advertisement associated with the party that won the advertising space auction according to the terms and conditions associated with the advertising space that was the subject of the auction.

In an example embodiment, the server 153 provides the content accessible by the user 101 through the web browser 117 or shopping application 113 on the user computing device 110, including but not limited to html documents, images, style sheets, and scripts. In an example embodiment, the server 153 supports the advertising platform system website 157.

In an example embodiment, the website 157 hosts one or more merchant system 120 advertisements on one or more regions of the website 157 that the advertising system 130 bids for on behalf of the merchant system 120 in one or more respective advertising space auctions hosted by the advertising platform system 150. In an example embodiment, the website 157 is accessible over the network 140 via the web browser 117 of the user computing device 110 and/or via the shopping application 113 of the user computing device 110.

In an example embodiment, the data storage unit 159 comprises a local or remote data storage structure accessible to the advertising platform system 159 suitable for storing information. In an example embodiment, the data storage unit 159 stores encrypted information, such as HTML5 local storage. In an example embodiment, the data storage unit 159 is used by the advertising platform system 150 to store statuses of advertising space auctions and to store bids received from advertising systems 130 for advertising space auctions.

It will be appreciated that the network connections shown are example and other means of establishing a communications link between the computers and devices can be used. Moreover, those having ordinary skill in the art having the benefit of the present disclosure will appreciate that the user computing device 110, the merchant system 120, the merchant system call center 121, the advertising system 130, and the advertising platform system 150 illustrated in FIG. 1 can have any of several other suitable computer system configurations. For example, a user computing device 110 embodied as a mobile phone or handheld computer may or may not include all the components described above.

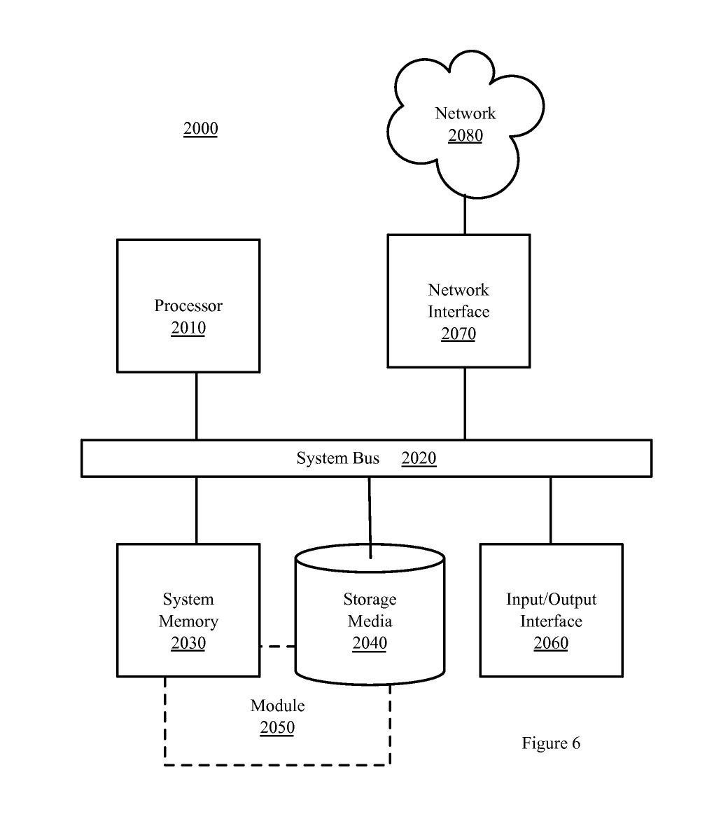

In example embodiments, the network computing devices and any other computing machines associated with the technology presented herein may be any type of computing machine such as, but not limited to, those discussed in more detail with respect to FIG. 6. Furthermore, any modules associated with any of these computing machines, such as modules described herein or any other modules (scripts, web content, software, firmware, or hardware) associated with the technology presented herein may by any of the modules discussed in more detail with respect to FIG. 6. The computing machines discussed herein may communicate with one another as well as other computer machines or communication systems over one or more networks, such as network 140. The network 140 may include any type of data or communications network, including any of the network technology discussed with respect to FIG. 6.

### Example Processes

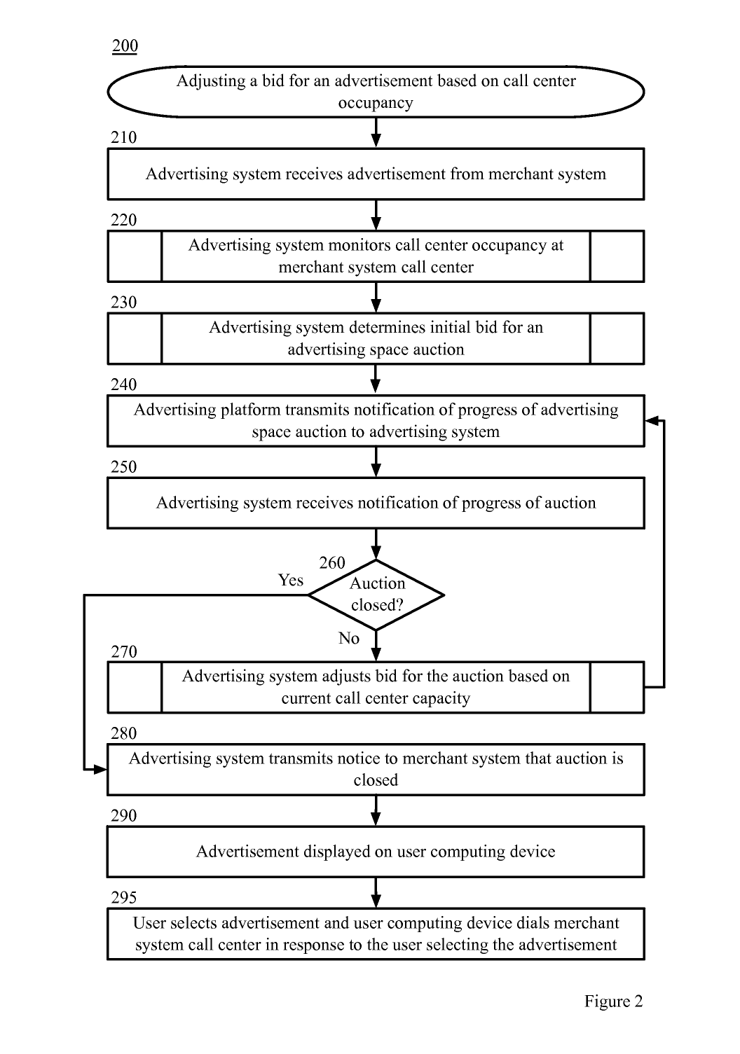

The example methods illustrated in FIGS. 2-5 are described hereinafter with respect to the components of the example operating environment 100. The example methods of FIGS. 2-5 may also be performed with other systems and in other environments.

FIG. 2 is a block diagram depicting a method 200 for adjusting bids for advertising spaces based on merchant system call center 121 occupancy, in accordance with certain example embodiments. The method 200 is described with reference to the components illustrated in FIG. 1.

In block 210, the advertising system 130 receives an advertisement from a merchant system 120. For example, the merchant system 120 designs or otherwise generates an advertisement and transmits the advertisement to the advertising system 130. In another example, the advertising system 130 designs or otherwise generates an advertisement for the merchant system 130. An example advertisement comprises an advertisement that may be displayed on a website or web-based application accessible via a user computing device 110 over a network 140. The example advertisement may comprise an advertisement, that when selected by a user 101 via a user computing device 110, causes the user computing device 110 to initiate a telephone call with a call center 121 associated with the merchant system 120 that generated the advertisement. The example advertisement may conform to standards set by an advertising system 130 or an advertising platform system 150. For example, the standards may comprise a predetermined display size, a predetermined file size, or a predetermined duration (for video or audio advertisements). A merchant system 120 may transmit a plurality of advertisements to the advertising system 130.

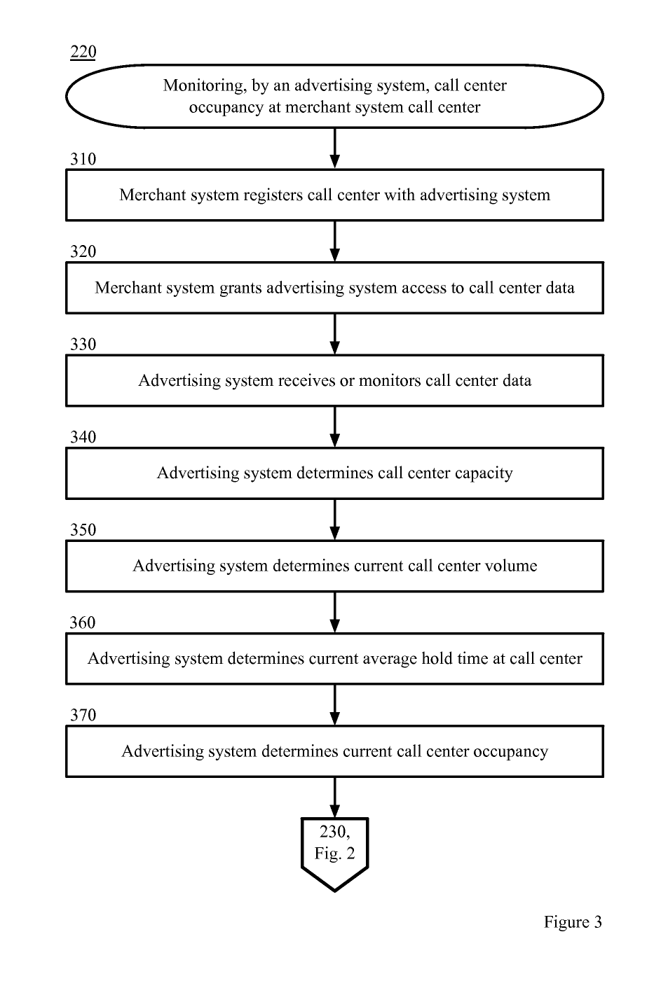

In block 220, the advertising system 130 monitors call center 121 occupancy at the merchant system 120 call center 121. The method for monitoring, by an advertising system 130, call center 121 occupancy at a merchant system call center 121 is described in more detail hereinafter with reference to the method described in FIG. 3.

FIG. 3 is a block diagram depicting a method 220 for monitoring, by an advertising system 130, call center occupancy at a merchant system call center 121, in accordance with certain example embodiments. The method 220 is described with reference to the components illustrated in FIG. 1.

In block 310, the merchant system 120 registers the call center 121 with the advertising system 130. In an example embodiment, the advertising system 130 assigns the call center 121 a call center 121 identifier and associates the call center 121 identifier with a merchant system 120 identifier. For example, the call center 121 identifier may be associated with a call center computing device 123 that monitors and/or collects call center 121 data from the call center 121. In this example, the merchant system 120 communicates the call center computing device 123 identifier and the merchant system 120 identifier to the advertising system 130.

In block 320, the merchant system 120 grants the advertising system 130 access to call center 121 data. In an example embodiment, the merchant system 120 continuously or periodically transmits call center 121 data via the network 140 to the advertising system 130. In another example embodiment, the advertising system 130 periodically transmits a request via the network 140 for call center 121 data to the merchant system 120 and the merchant system 120 transmits call center 121 data via the network 140 to the advertising system 130 in response to receiving the request for call center 121 data. In yet another example embodiment, the merchant system 120 grants the advertising system 130 remote access to the computing device 123 associated with the call center 121 and the merchant system 120 accesses the call center 121 data continuously or periodically via the computing device 123 over the network 140.

In block 330, the advertising system 130 receives or monitors call center 121 data. In an example embodiment, the call center computing device 123 is communicatively coupled to one or more telephone computing devices at the call center 121. In this example embodiment, the call center computing device 123 is able to determine a status for each of the one or more telephone computing devices at the call center 121, for example, when the particular telephone computing device is currently receiving a call, currently answering a call, currently on a call, available to take a call, unavailable to take a call, and/or any other applicable status of the particular telephone device. The call center computing device 123 may determine a status for each of the telephone computing devices, for example, “available,” “not available, receiving a call,” “not available, currently on a call,” or “not available.” For example, the status identifier “available” signifies that a telephone device is not currently on a call but is able to take a call. In another example, the status identifier, “not available, receiving a call” means that the telephone device is receiving a call but the agent associated with the telephone device has not answered the call yet. In another example, the status identifier “not available, currently on a call” means that the telephone device is current on a call and therefore not able to take a call. In yet another example, the status identifier “not available” means that the telephone is not currently on a call and not able to take calls. For example, the telephone computing device may be disabled. In an example embodiment, the call center computing device 123 transmits call center 121 data comprising a status for each of the one or more telephone computing devices at the call center 121. In an example embodiment, the merchant system 120 and/or call center computing device 123 transmit call center 121 data that comprises a current number of agents able to answer telephone calls at the call center 121.

In block 340, the advertising system 130 determines call center 121 capacity. An example call center 121 capacity comprises a total number of calls that may be answered currently at the call center 121. In an example embodiment, the advertising system 130 calculates the current call center 121 capacity by determining, from the received call center 121 data, a first number comprising a current number of telephone devices at the call center 121 able to take customer calls, determining a second number comprising a current number of agents at the call center 121 able to answer customer calls, and selecting the lesser of the first or the second number. For example, if there are 10 available telephone devices at the call center 121 and 12 available agents at the call center 121, the call center 121 capacity comprises 10 calls because, even though there are 12 agents, only 10 telephone devices may be used at any one time. In another example, if there are 18 available telephone devices at the call center 121 and 12 available agents at the call center 121, the call center 121 capacity comprises 12 calls because, even though there are 18 available telephone devices, only 12 agents may answer calls at any one time. In an example embodiment, the advertising system 130 determines, based on the call center 121 data, the number of telephone devices comprising a status of “available,” “not available, receiving a call,” and “not available, currently on a call.”

In block 350, the advertising system 130 determines current call center 121 volume. An example current call center 121 volume comprises a current number of telephone devices at the call center 121 which are currently being used by a respective associated agent of the merchant system 120 to attend a customer call. In an example embodiment, the advertising system 130 determines the current call center 121 volume based on the received call center 121 data comprising status identifiers for each of the one or more telephone devices at the call center 121. For example, the advertising system 130 calculates the current call center 121 volume by determining the number of telephone devices comprising the status identifiers of “not available, receiving a call” and “not available, currently on a call.”

In block 360, the advertising system 130 determines a current average hold time at the call center 121. For example, the advertising system 130 may continuously receive and/or monitor call center 121 data. The advertising system 130 may log a time stamp each time each of the one or more telephone computing devices at the call center 121 changes a status. In an example, advertising system 130 determines a most recent hold time for a particular telephone computing device by determining the length of time between a times stamp associated with a status identifier of “not available, receiving a call” and a time stamp associated with a status identifier of “not available, on a call.” In this example, the advertising system 130 calculates a most recent hold time for each of the one or more telephone devices at the call center 121. The advertising system 130 may calculate the average hold time at the call center 121 by averaging the most recent hold times for telephone computing devices 121 comprising a status of “not available, receiving a call” comprising a timestamp for the status within a threshold amount of time before the current time at which the average hold time is calculated.

In block 370, the advertising system 130 determines a current call center 121 occupancy. In an example embodiment, the advertising system 130 determines the current call center 121 occupancy as a function of the current call center 121 volume and the current call center 121 capacity. For example, the current call center 121 occupancy may comprise a proportion comprising the current call center 121 volume divided by the current call center 121 capacity. In this example, the current call center 121 occupancy would be a number greater than or equal to 0 and less than or equal to 1. In another example embodiment, the advertising system 130 determines the current call center 121 occupancy based on the average call center 121 hold time. In yet another example embodiment, the advertising system 130 may determine the current call center 121 occupancy based on one or more of the average call center 121 hold time, the current call center 121 capacity, and the current call center 121 volume.

In an example embodiment, the advertising system 130 periodically determines the current call center 121 occupancy. For example the advertising system 130 determines the current call center 121 occupancy every 30 seconds. In another example embodiment, the advertising system 130 determines the call center 121 occupancy each time the advertising system 130 calculates and/or determines a bid for an advertising space auction.

From block 370, the method 220 proceeds to block 230 of FIG. 2.

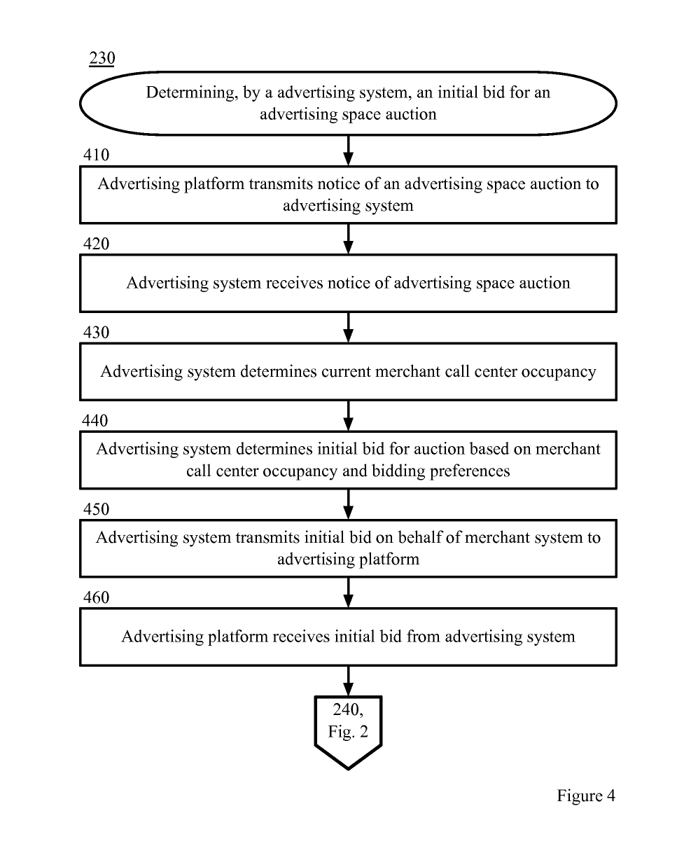

Returning to FIG. 2, in block 230, the advertising system 130 determines an initial bid for an advertising space auction. The method for determining, by an advertising system 130, an initial bid for an advertising space auction is described in more detail hereinafter with reference to the method 230 described in FIG. 4.

FIG. 4 is a block diagram depicting a method 230 for determining, by an advertising system 130, an initial bid for an advertising space auction, in accordance with certain example embodiments. The method 230 is described with reference to the components illustrated in FIG. 1.

In block 410, an advertising platform system 150 transmits notice of an advertising space auction to the advertising system 130. For example, the advertising platform system 150 transmits a notice of an auction for a website 157 advertisement to the advertising system 130 via the network 150. In an example embodiment, the notice of the advertising space auction comprises details associated with the auction. For example, the notice comprises an opening time and a closing time for the auction, a description of the advertising space associated with the auction, a minimum opening bid for the auction, an advertising space auction identifier, and any other relevant or useful information. The description of the advertising space may comprise details concerning the location of the advertisement, the time of the advertisement, and/or the duration of the advertisement. For example, the description of the advertising space reads “two minute display segment on banner region of website 157 for Friday Aug. 21, 2015.” An example advertising space identifier is used by the advertising space platform 140 to identify the advertising space auction. In this example, the advertising system 130 submits bids for the advertising space auction along with the advertising space auction identifier so that the advertising platform 140 can associate the bids with the appropriate auction. An advertising space auction provided for a website 157 advertising space may be for a pop-up advertisement on the website 157, a banner region of the website 157, or any other appropriate advertising space on an applicable region of the website 157.

In block 420, the advertising system 130 receives the notice of the advertising space auction. In an example embodiment, the advertising system 130 receives multiple notices associated with multiple corresponding advertising space auctions from one or more advertising platforms 150.

In block 430, the advertising system 130 determines current merchant system call center 121 occupancy. In an example embodiment, the advertising system 130 continuously or periodically monitors call center occupancy at a merchant system call center 121. For example, the advertising system 130 receives call center 121 data or monitors call center 121 data.

In certain example embodiments, the advertising system 130 determines a current call center 121 occupancy based at least in part on a current call center 121 capacity and a current call center 121 volume. In an example embodiment, the advertising system 130 determines a call center 121 capacity. For example, the call center 121 capacity may comprise the maximum number of calls that may be accepted by the call center at the current time. The call center 121 capacity may vary depending on the time of the day, day of the week, day of the month, season of the year, or month of the year. In another example, the call center 121 data comprises the call center 121 capacity comprising a number of current merchant system 120 agents currently able to answer telephone calls at the call center 121. In an example embodiment, the advertising system 130 determines a current call center 121 volume, which may be based at least in part on a current average hold time at the call center 121 or may comprise the current number of telephone calls in progress at the call center 121. In an example embodiment, the advertising system 130 may determine a current average hold time at the call center 121. For example, the advertising system 130 determines the current average length of time for a call to the call center 121 to be answered by an agent at the call center 121. In an example embodiment, the advertising system determines a current call center occupancy for the call center 121 based at least in part on the current call center 121 capacity and the current call center 121 volume. In an example, the current call center 121 occupancy is the current call center volume divided by the current call center capacity. In another example, the current call center occupancy is further based on the current average hold time. In yet another example, the current call 121 occupancy is based on the current average hold time instead of the current call center 121 volume and/or the current call 121 center capacity.

In certain example embodiments, the advertising system 130 communicates with or remotely accesses a computing device 123 of the merchant system call center 121 to determine one or more of the current call center 121 capacity, the current call center 121, and/or the current call center 121 occupancy. For example, as previously described in blocks 310-370 in FIG. 3, the call center 121 computing device 123 may monitor the status of each of one or more telephone computing devices at the call center 121 and may transmit the status data to the advertising system 130 via the network 140. In another example, instead of receiving data transmitted by the computing device 123, the advertising system 130 may remotely access the computing device 123 via the network 140 to retrieve the call center 121 data. In an example embodiment, the computing device 123 monitoring the call center 121 may determine one or more of the current call center 121 capacity, the current call center 121, and/or the current call center 121 occupancy and transmit and/or allow remote access to one or more of the current call center 121 capacity, the current call center 121, and/or the current call center 121 occupancy to the advertising system 130. In another example embodiment, the advertising system 130 receives status data associated with the one or more telephone computing devices and determines one or more of the current call center 121 capacity, the current call center 121, and/or the current call center 121 occupancy based on the received status data associated with the one or more telephone computing devices.

In block 440, the advertising system 130 determines an initial bid for the advertising space auction based on merchant system call center 121 occupancy and merchant system 120 bidding preferences. In certain example embodiments, in addition to transmitting the advertisement to the advertising system 130, the merchant system 120 defines bidding parameters for the advertising system 130. For example, the merchant system 120 defines a low bidding threshold, a high bidding threshold, and acceptable bidding intervals according to current call center 121 occupancy and/or according to changes in current call center 121 occupancy. For example, the merchant system may define $1.00 as a low bidding threshold for a 24 hour advertising space on a website 157 and $100.00 as the high bidding threshold. In this example, the merchant system 120 may define $1.00 as an acceptable bid when the merchant system call center 121 occupancy is at 100% and $100.00 as an acceptable bid when the merchant system 120 call center 121 occupancy is at 0%. In this example, the merchant system 120 may instruct the advertising system 130 to increase the bid for the advertising space by $1.00 for each decrease in call center 121 occupancy of 1% and decrease the bid for the advertising space by $1.00 for each increase in the call center 121 occupancy of 1%. For example, if the current bid was $40.00 in an advertising space auction and the call center 121 occupancy decreased by 5%, the bidding parameters may instruct the advertising to increase the bid by $5.00 to $45.00 for the advertising space. In an example embodiment, the advertising system 130 receives the merchant system 120 bidding preferences. In an example embodiment, the advertising system 130 determines an initial bid based on the merchant system 120 bidding parameters. In other example embodiments, the advertising system 130 may determine an initial bid based on the call center 121 capacity and other factors in addition to or instead of the merchant system 120 bidding parameters.

In block 450, the advertising system 130 transmits the initial bid on behalf of the merchant system 120 to the advertising platform system 150. For example, the advertising system 130 transmits the initial bid to the merchant system 120 to the advertising platform system 150 via the network 150. In an example embodiment, the advertising system 130 transmits an advertising space auction identifier, a merchant system 120 identifier, and/or an advertising system 130 identifier along with the initial bid so that the advertising platform system 150 may identify the advertising space auction associated with the initial bid, merchant system 120 associated with the initial bid, and/or the advertising system 130 associated with the initial bid. In an example embodiment, the advertising system 130 may transmit, to the advertising platform system 150, the advertisement received from the merchant system 120 that would be used in the advertising space should the merchant system 120 win the advertising space auction.

In block 460, the advertising platform system 150 receives the initial bid from the advertising system 130. The advertising platform system 150 may also receive an advertisement, an advertising space auction identifier, a merchant system 120 identifier, and/or an advertising system 130 identifier. In this example embodiment, the advertising platform system 150 may store the initial bid and such associated data received from the advertising system 130 in a storage device of the advertising platform system 150. In an example embodiment, the advertising platform system 150 associates one or more of the advertisement, the advertising space auction identifier, the merchant system 120 identifier, and/or the advertising system 130 identifier.

In an example embodiment, the advertising platform system 150 manages the advertising space auction as bids are received from one or more advertising systems 130 and/or one or more merchant systems 120. For example, each time the advertising platform system 150 receives a bid from an entity along with the advertising space auction identifier, the advertising platform system 150 associates the received bid with the advertising space auction. In this example, initial bids received from advertising systems 130 and/or merchant systems 120 may comprise advertisements intended for use in the advertising space that is the subject of the auction. The advertising platform system 150 may further associate a received advertising system 130 identifier and/or a received merchant system 120 identifier with the received bid. In an example embodiment, the advertising platform system 150 may enter each bid as it is received into a table, database, or other appropriate format. In an example embodiment, the advertising platform system 150 may periodically determine a status of the advertising space auction, for example, every ten seconds. For example, the advertising platform system 150 may extract a table where bids and associated data are logged for the advertising space auction. In this example, the advertising platform system 150 may determine the highest received bid and the associated advertising system 130 identifier and/or associated merchant system 120 identifier.

From block 460, the method 230 proceeds to block 240 in FIG. 2.

Returning to block 240, in FIG. 2, the advertising platform system 150 transmits a notification of progress of the advertising space auction to the advertising system 130. In an example embodiment, the notification of progress of the advertising space auction comprises a notification that the auction is still in progress. In another example embodiment, the notification comprises a notification that the auction is finished and that the merchant system 120 or associated advertising system 130 won the auction. In yet another example embodiment, the notification comprises a notification that the auction is finished and that the merchant system 120 or associated advertising system 130 did not win the auction. In an example embodiment, the notification further comprises a price associated with the winning bid for the advertising space auction. In an example embodiment, the advertising platform system 150 transmits the notification of progress of the auction to the advertising system 130 via the network 150.

In an example embodiment, the advertising platform system 150 receives one single bid from each advertising system 130 and/or merchant system 120 participating in the advertising space auction and determines a winning bid comprising the highest bid of the received bids. In this example embodiment, the advertising platform system 150 does not receive subsequent bids from any of the participating merchant systems 120 or participating advertising systems 130. In this example embodiment, the advertising platform system 150 may open the auction for a predetermined length of time, only accept bids during the predetermined length of time, and reject subsequent bids from any advertising system 130 and/or any merchant system 120 from which a bid was received previously for the advertising space auction. For example, the predetermined length of time for the auction may be five minutes. In this example embodiment, the advertising platform system 150, at the end of the predetermined length of time, identifies the highest received bid and identifies the advertising system 130 or merchant system 120 corresponding to the highest received bid. For example, the advertising platform system 150 may retrieve a table comprising the bids for the advertising space auction, identity a data in the table comprising the highest bid for the auction, and identify a merchant system 120 or advertising system 130 associated with the highest bid in the table. In this example, the advertising system 130 generates a notification of progress of the auction and transmits the notification of progress of the auction to each merchant system 120 and each advertising system 130 listed in the table as having provided a bid for the auction. In this example embodiment, in which a single bid is received from each merchant system 120 and/or advertising system 130 participating in the advertising space auction, notifications of progress comprise a notification that the auction is closed and a notification as to whether the entity receiving the notification of progress won the auction or did not win the auction. In this example embodiment, if the entity receiving the notification of progress did not win the advertising space auction, the notification of progress may further comprise a merchant system 120 name and/or advertising system 130 name associated with the merchant system 120 and/or advertising system 130 that won the auction.

In other example embodiments described herein, the advertising platform system 150 may receive one or more bids from each participating advertising system 130 and/or merchant system 120 for the advertising space auction. In this example embodiment, the advertising platform system 150 may receive subsequent bids from any of the participating merchant systems 120 or participating advertising systems 130 that provide an initial bid. In this example embodiment, the advertising platform system 150 may open the auction for a predetermined length of time and only accept bids during the predetermined length of time. For example, the predetermined length of time for the auction may be five minutes. In this example embodiment, the advertising platform system 150, at the end of the predetermined length of time, identifies the highest received bid and identifies the advertising system 130 or merchant system 120 corresponding to the highest received bid. For example, the advertising platform system 150 may retrieve a table comprising the bids for the advertising space auction, identity a data in the table comprising the highest bid for the auction, and identify a merchant system 120 or advertising system 130 associated with the highest bid in the table. In this example, the advertising system 130 generates a notification of progress of the auction and transmits the notification of progress of the auction to each merchant system 120 and each advertising system 130 listed in the table as having provided a bid for the auction. In this example embodiment, in one or more bids are received from each merchant system 120 and/or advertising system 130 participating in the advertising space auction, notifications of progress comprise a notification that the auction is closed or open. For example, the advertising platform system 150 may send notification that the auction is open if the predetermined length of time for the auction has not yet passed. An example notification that the auction is open may further comprise a numerical amount of the current highest bid in the auction. In another example, the advertising platform system 150 may send notification that the auction is closed when the predetermined length of time for the auction has passed. A notification that the advertising space auction is closed may further comprise notification as to whether the entity receiving the notification of progress won the auction or did not win the auction. In this example embodiment, if the entity receiving the notification of progress did not win the advertising space auction, the notification of progress may further comprise a merchant system 120 name and/or advertising system 130 name associated with the merchant system 120 and/or advertising system 130 that won the auction.

In block 250, the advertising system 130 receives the notification of progress of the advertising space auction. For example, the advertising system 130 receives the notification of progress of the auction via the network 140.

In block 260, the advertising system 130 determines whether the advertising space auction is closed or open. In an example embodiment, the notification of the progress of the auction comprises an indication as to whether the auction is open or closed and the advertising system 130 determines either that the advertising space auction is closed or open based on the indication.

If the advertising system 130 determines that the advertising space auction is closed, the method 200 proceeds to block 280 in FIG. 2. For example, the advertising system 130 transmits a notice to the merchant system 120 that the advertising space auction is closed. In an example embodiment, the indication that the auction is closed further comprises an indication of the merchant system 120 and/or advertising system 130 that won the auction and the associated winning bid. In this example embodiment, the advertising system 130 may transmit a notice to the merchant system 120 that the advertising space auction is closed may further comprise an indication of the merchant system 120 and/or advertising system 130 and the associated winning bid. In this example, the notice may comprise an indication that the merchant system 120 won the advertising space auction.

Returning to 260, if the advertising system 130 determines that the advertising space auction is open, the method 200 proceeds to block 270 in FIG. 2. For example, in certain example embodiments, the advertising platform system 150 may receive subsequent bids from one or more advertising systems 130 and/or merchant systems 120 that previously submitted an initial bid. In an example embodiment, the advertising system 130 may periodically evaluate whether a bid for the advertising space auction needs to be adjusted based on changes in call center 121 occupancy or other appropriate call center 121 data.

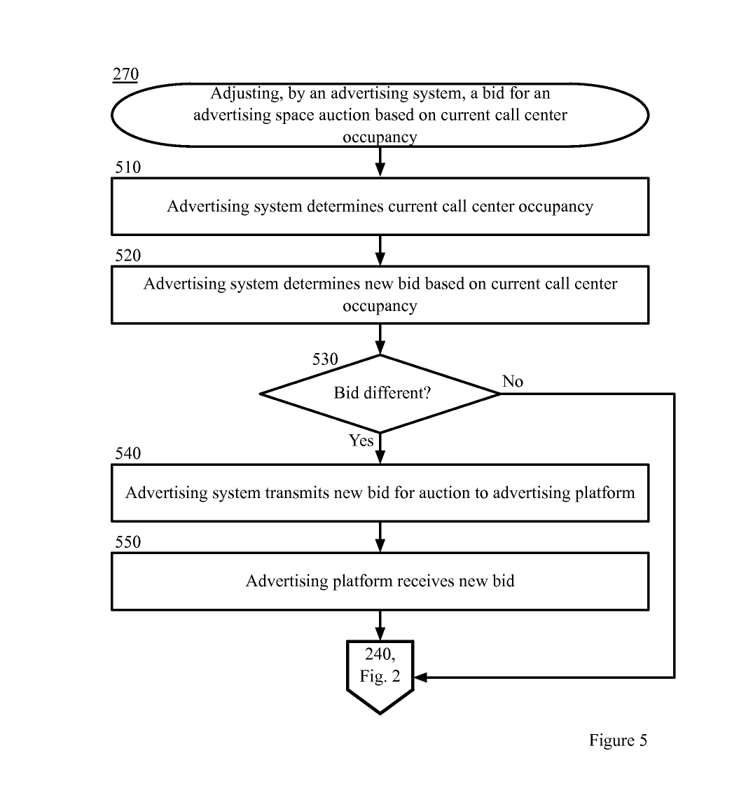

In block 270, the advertising system 270 adjusts the bid for the advertising space auction based on current call center capacity. The method for adjusting, by an advertising system 130, a bid for an advertising space auction based on current call center 121 occupancy is described in more detail hereinafter with reference to the method 270 described in FIG. 5.

FIG. 5 is a block diagram depicting a method 270 for adjusting, by an advertising system 130, a bid for an advertising space auction based on current call center 121 occupancy, in accordance with certain example embodiments. The method 270 is described with reference to the components illustrated in FIG. 1.

In block 510, the advertising system 130 determines a current call center 121 occupancy. A method for determining a current call center 121 occupancy is described in block 430 in FIG. 4. For example, the advertising system 130 determines a current call center 121 occupancy based at least in part on a current call center 121 capacity and a current call center 121 volume. In an example embodiment, the advertising system 130 determines a call center 121 capacity. For example, the call center 121 capacity may comprise the maximum number of calls that may be accepted by the call center at the current time. The call center 121 capacity may vary depending on the time of the day, day of the week, day of the month, season of the year, or month of the year. In another example, the call center 121 data comprises the call center 121 capacity comprising a number of current merchant system 120 agents currently able to answer telephone calls at the call center 121. In an example embodiment, the advertising system 130 determines a current call center 121 volume, which may be based at least in part on a current average hold time at the call center 121 or may comprise the current number of telephone calls in progress at the call center 121. In an example embodiment, the advertising system 130 may determine a current average hold time at the call center 121. For example, the advertising system 130 determines the current average length of time for a call to the call center 121 to be answered by an agent at the call center 121. In an example embodiment, the advertising system determines a current call center occupancy for the call center 121 based at least in part on the current call center 121 capacity and the current call center 121 volume. In an example, the current call center 121 occupancy is the current call center volume divided by the current call center capacity. In another example, the current call center occupancy is further based on the current average hold time. In yet another example, the current call 121 occupancy is based on the current average hold time instead of the current call center 121 volume and/or the current call 121 center capacity.

In block 520, the advertising system 130 determines a new bid based on the current call center 121 occupancy. In another example embodiment, the advertising system 130 determines a new bid based on a change in the current call center 121 occupancy. In an example embodiment, the advertising system 130 determines a new bid based on both the current call center 121 occupancy and merchant system 120 bidding parameters. For example, the merchant system 120 defines a low bidding threshold, a high bidding threshold, and acceptable bidding intervals according to current call center 121 occupancy and/or according to changes in current call center 121 occupancy. For example, the merchant system 120 previously transmitted bidding parameters to the advertising system 130 that define $1.00 as a low bidding threshold for a 24 hour advertising space on a website 157 and $100.00 as the high bidding threshold. In this example, the merchant system 120 may define $1.00 as an acceptable bid when the merchant system call center 121 occupancy is at 100% and $100.00 as an acceptable bid when the merchant system 120 call center 121 occupancy is at 0%. In this example, the merchant system 120 may instruct the advertising system 130 to increase the bid for the advertising space by $1.00 for each decrease in call center 121 occupancy of 1% and decrease the bid for the advertising space by $1.00 for each increase in the call center 121 occupancy of 1%. For example, if the current bid was $40.00 in an advertising space auction and the call center 121 occupancy decreased by 5%, the bidding parameters may instruct the advertising to increase the bid by $5.00 to $45.00 for the advertising space. In an example embodiment, the advertising system 130 receives the merchant system 120 bidding preferences. In an example embodiment, the advertising system 130 determines an initial bid based on the merchant system 120 bidding parameters. In other example embodiments, the advertising system 130 may determine an initial bid based on the call center 121 capacity and other factors in addition to or instead of the merchant system 120 bidding parameters. Generally, when call center 121 occupancy increases, a bid for an advertising space should decrease and when call center 121 occupancy decreases, a bid for an advertising space should increase.

In block 530, the advertising system 130 determines whether the new bid is different from a previous bid. For example, the previous bid or initial bid was $5.25 and the new bid is $5.21. In this example, the new bid is different from the previous bid. In another example, the advertising system 130 determines whether the new bid exceeds a threshold difference from the previous bid. For example, the previous bid or initial bid was $5.25, the new bid is $5.21, and the threshold is $0.10. In this example, since the difference between the two bids, $0.04, is less than the threshold, $0.10, the advertising system 130 determines that then new bid does not exceed a threshold difference from the previous or initial bid.

If the new bid is not different from the previous bid, the method 270 proceeds to block 240 in FIG. 2. In another example, if the new bid does not exceed a threshold difference from the previous bid, the method 270 proceeds to block 240 in FIG. 2. For example, the advertising system 130 does not submit a new bid and waits for an updated status notification from the advertising platform system 150 concerning the status of the advertising space auction. In this example, in response to receiving the updated status notification from the advertising platform system 150 concerning the status of the advertising space auction, the advertising system 130 determines a subsequent new bid for the advertising space auction.

Returning to block 530, in FIG. 5, if the advertising system 130 determines that the new bid is different from a previous bid, the method 270 proceeds to block 540 in FIG. 5. In another example, if the advertising system 130 determines that the new bid exceeds a threshold difference from the previous bid, the method 270 proceeds to block 540 in FIG. 5.

In block 540, the advertising system 130 transmits the new bid for the advertising space auction to the advertising platform system 150. For example, the advertising system 130 may transmit the new bid along with an advertising space auction identifier, a merchant system 120 identifier, and/or an advertising system 130 identifier. In an example embodiment, the advertising system 130 transmits the new bid to the advertising platform system 150 via the network 140.

In block 550, the advertising platform system 150 receives the new bid. For example, the advertising platform system 150 receives the new bid via the network 140. In this example embodiment, the advertising platform system 150 may store the received new or subsequent bid and associated data received from the advertising system 130 in a storage device of the advertising platform system 150. In an example embodiment, the advertising platform system 150 associates one or more of the received advertising space auction identifier, merchant system 120 identifier, and/or advertising system 130 identifier with the received new or subsequent bid. In an example embodiment, the advertising platform system 150 extracts a table or other data log of bids for the advertising space auction associated with the new or subsequent bid based on the received advertising space auction identifier. For example, the advertising platform system 150 extracts a file comprising the table or data log having a file name comprising the advertising space auction identifier from the data storage unit 159. In this example embodiment, the advertising platform system 150 inserts the received new or subsequent bid into the table or data log. In this example embodiment, the advertising platform system 150 may additionally insert data received with and/or associated with the new or subsequent bid to the table or data log, for example, the merchant system 120 identifier and/or the advertising system 130 identifier.

As previously discussed, the advertising platform system 150 manages the advertising space auction as bids are received from one or more advertising systems 130 and/or one or more merchant systems 120. For example, each time the advertising platform system 150 receives an initial, new, or subsequent bid from an entity along with the advertising space auction identifier, the advertising platform system 150 associates the received bid with the advertising space auction. In this example, initial bids received from advertising systems 130 and/or merchant systems 120 may comprise advertisements intended for use in the advertising space that is the subject of the auction. The advertising platform system 150 may further associate a received advertising system 130 identifier and/or a received merchant system 120 identifier with the received bid. In an example embodiment, the advertising platform system 150 may enter each bid as it is received into a table, database, or other appropriate format. In an example embodiment, the advertising platform system 150 may periodically determine a status of the advertising space auction, for example, every ten seconds. For example, the advertising platform system 150 may extract a table where bids and associated data are logged for the advertising space auction. In this example, the advertising platform system 150 may determine the highest received bid and the associated advertising system 130 identifier and/or associated merchant system 120 identifier.

From block 550, the method 550 proceeds to block 240 in FIG. 2.

Returning to FIG. 2, in block 240, the advertising platform system 150 transmits a notification of progress of the advertising space auction to the advertising system 130. In an example embodiment, the notification of progress of the advertising space auction comprises a notification that the auction is still in progress. In another example embodiment, the notification comprises a notification that the auction is finished and that the merchant system 120 or associated advertising system 130 won the auction. In yet another example embodiment, the notification comprises a notification that the auction is finished and that the merchant system 120 or associated advertising system 130 did not win the auction. In an example embodiment, the notification further comprises a price associated with the winning bid for the advertising space auction. In an example embodiment, the advertising platform system 150 transmits the notification of progress of the auction to the advertising system 130 via the network 150.

In block 250, the advertising system 130 receives the notification of progress of the advertising space auction. For example, the advertising system 130 receives the notification of progress of the auction via the network 140.

In block 260, the advertising system 130 determines whether the advertising space auction is closed. In an example embodiment, the notification of the progress of the auction comprises an indication as to whether the auction is open or closed and the advertising system 130 determines either that the advertising space auction is closed or open based on the indication.

If the advertising system 130 determines that the advertising space auction is not closed, the method 200 proceeds to block 270 in FIG. 2. For example, the advertising system 130 transmits a notice to the merchant system 120 that the advertising space auction is closed. In an example embodiment, the indication that the auction is closed further comprises an indication of the merchant system 120 and/or advertising system 130 that won the auction and the associated winning bid. In this example embodiment, the advertising system 130 may transmit a notice to the merchant system 120 that the advertising space auction is closed may further comprise an indication of the merchant system 120 and/or advertising system 130 and the associated winning bid. In this example, the notice may comprise an indication that the merchant system 120 won the advertising space auction.

Returning to block 260, if the advertising system 130 determines that the advertising space auction is closed, the method 200 proceeds to block 280 in FIG. 2. For example, the advertising system 130 transmits a notice to the merchant system 120 that the advertising space auction is closed. In an example embodiment, the indication that the auction is closed further comprises an indication of the merchant system 120 and/or advertising system 130 that won the auction and the associated winning bid. In this example embodiment, the advertising system 130 may transmit a notice to the merchant system 120 that the advertising space auction is closed may further comprise an indication of the merchant system 120 and/or advertising system 130 and the associated winning bid. In this example, the notice may comprise an indication that the merchant system 120 won the advertising space auction.

In block 280, the advertising system 130 transmits notice to merchant system 120 that the auction is closed. In an example embodiment, the advertising system 130 transmits the notice to the merchant system 120 that the advertising space auction is closed via the network 140.

In an example embodiment described in blocks 290 and 295 below, the advertising system 130 won the advertising space auction to display the advertisement received from the merchant system 120. In this example embodiment, the advertisement is displayed on the website 157 such that a user computing device 110 may access, via the network 140, the website 157 and display the advertisement via the web browser 117 and/or shopping application 113.

In block 290, the advertisement is displayed on the user computing device 110. In an example embodiment, the user 101 accesses the website 157 of the advertising platform system 150 via the user computing device 110. For example, the user 101 accesses the website 157 by entering the website 157 address in the web browser 117. In another example, the user 101 accesses the website 157 by clicking on a link from another website using the web browser 117 or shopping application 113. In yet another example, the user 101 accesses the website 157 by selecting a user interface 111 object via the shopping application 113 that directs the shopping application 113 to access the website 157. In an example embodiment, the user computing device 110 displays the advertisement via the user interface 111 of the user computing device 110. In this example embodiment, the user 101 may have to scroll through the website 157 via the user interface 111 to display a region of the website 157 where the advertisement is displayed.

In block 295, the user 101 selects the advertisement and the user computing device 110 dials the merchant system 120 call center 121. In an example embodiment, the user 101 selects the advertisement by actuating one or more user interface 111 objects. For example, the advertisement and/or a region of the advertisement comprises a user interface 111 object. For example, the user 101 selects an image in the advertisement or a link in the advertisement that reads “click here to order.” In an example embodiment, in response to the user 101 selecting the advertisement, the advertising platform system 150 receives an indication of the user 101 selection of the advertisement via the network 140. In an example embodiment, in response to receiving the indication of the user 101 selection of the advertisement, the advertising platform system 150 transmits instructions via the network 140 and/or website 157 to the user computing device 110 instructing the user computing device 110 to initiate a telephone call with the call center 121 associated with the advertisement. In an example embodiment, the advertising platform system 150 receives an advertisement identifier associated with the advertisement along with the indication that the user 101 selected the advertisement. In this example embodiment, the advertising platform system 150 comprises a table, database, or other data log that lists advertisement identifiers and corresponding merchant system call center 121 telephone numbers. In this example embodiment, the advertising platform system 150 extracts the call center 121 telephone number associated with the received advertisement identifier and includes the call center 121 telephone number in the instructions sent to the user computing device 110 instructing the user computing device 110 to dial the call center 121. In another example, the advertisement displayed on the user computing device 110 comprises a telephone number associated with the merchant system call center 121 and the user 101 inputs the telephone number into the user computing device 110 via the user interface 111 and instructs the user computing device 110 to dial the telephone number. In this example, the user computing device 110 establishes a telephone call with the call center 121 after the user 101 dials the number displayed in the advertisement.

In an example embodiment, the user computing device 110 receives the instructions to dial the call center 121 via the website 157 over the network 140 or otherwise via the network 140. In an example embodiment, the user computing device 110 interprets the instructions to dial the call center 121 and activates a phone module 118 of the user computing device 110. In an example embodiment, the user computing device 110 initiates a telephone call with the call center 121 by dialing the number, via the phone module 118, received in the instructions from the advertising platform system 150. In an example embodiment, a cellular phone network communication channel, land line phone network communication channel, internet phone network communication channel, or other appropriate phone network communication channel is established between the user computing device 110 and the call center 121 identified by the number dialed by the user computing device 110. In an example embodiment, an operator of the call center 121 answers the user's 101 call and provides information about a product associated with the advertisement selected by the user 101.

### Other Example Embodiments

FIG. 6 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to bid for advertisements to place in advertising spaces based on current states of call centers associated with the advertisements, comprising:
receiving, by one or more computing devices associated with an advertisement system, an advertisement from a merchant computing system, wherein the advertisement comprises a link operable to transmit instructions to a user computing device to initiate a telephone call with a call center computing system associated with the advertisement upon selection of the link by a user operating the user computing device;
transmitting, by the one or more computing devices, to the call center computing system, a first request for call center data;
receiving, by the one or more computing devices and from the call center computing system, first call center data describing a first state of the call center computing system at a time at which the call center computing system receives the first request for call center data;
determining, by the one or more computing devices and based on the received first call center data, a first bid for an advertising space associated with an advertising space auction;
transmitting, by the one or more computing devices and to an advertising platform system, the first bid for the advertising space associated with the advertising space auction;
receiving, by the one or more computing devices and from the advertising platform system, a first status of the advertising space auction comprising notification that the advertising space auction is open;
in response to receiving the first status, transmitting, by the one or more computing devices and to the call center computing system, a second request for call center data;
receiving, by the one or more computing devices and from the call center computing system, second call center data describing a second state of the call center computing system at a time at which the call center computing system receives the second request for call center data;
determining, by the one or more computing devices and based on the received second call center data, a second bid for the advertising space associated with the advertising space auction, wherein the second bid is different from the first bid; and
transmitting, by the one or more computing devices and to an advertising platform system, the second bid for the advertising space associated with the advertising space auction.

2. The method of claim 1, wherein the first call center data comprises one or more of a call center capacity, a call center volume, and an average hold time, and wherein the second call center data comprises one or more of an updated call center capacity, an updated call center volume, and an updated average hold time.

3. The method of claim 1, wherein the call center computing system communicates with one or more telephone computing devices at a location of the call center computing system to determine a status of each of the one or more telephone computing devices at the location, and wherein the call center computing system determines the first call center data and the second call center data based at least on the status of each of the one or more telephone computing devices at the call center location.

4. The method of claim 3, wherein determining a status corresponding to one or more particular telephone computing devices comprises determining an available-in-use status that indicates that the particular one or more telephone computing devices are on a call or receiving a call.

5. The method of claim 3, wherein determining a status corresponding to one or more particular telephone computing devices comprises determining an available-not-in-use status that indicates that the particular one or more telephone computing devices are not on a call but are available to receive calls.

6. The method of claim 3, wherein determining a status corresponding to one or more particular telephone computing devices comprises determining an unavailable status that indicates that the particular one or more telephone computing devices are both not on a call and not able to receive calls.

7. The method of claim 1, further comprising receiving, by the one or more computing devices and from the merchant system, one or more bidding preferences, wherein the first and second bids for the advertising space auction are further determined based on the bidding preferences.

8. The method of claim 1, further comprising:
receiving, by the one or more computing devices and from the advertising platform system, a notice of commencement of the advertising space auction, the notice comprising one or more predefined specifications for advertisements that may be entered into the advertising space auction; and
determining, by the one or more computing devices, that the received advertisement conforms to the one or more predefined specifications, wherein the first request to the call center computing system for call center data is transmitted in response to receiving the notice of commencement of the advertising space auction and determining that the received advertisement conforms to the one or more predefined specifications.

9. The method of claim 8, wherein the one or more predefined specifications comprise one or more of a display size of an advertisement and a duration of an advertisement.

10. A computer program product, comprising:
a non-transitory computer-readable medium having computer-readable program instructions embodied thereon that when executed by a computer cause the computer to bid for advertisements to place in advertising spaces based on current states of call centers associated with the advertisements, the computer-readable program instructions comprising:
computer-readable program instructions to receive an advertisement from a merchant computing system, wherein the advertisement comprises a link operable to transmit instructions to a user computing device to initiate a telephone call with a call center computing system associated with the advertisement upon selection of the link by a user operating the user computing device;
computer-readable program instructions to receive, from the call center computing system, first call center data describing a first state of the call center computing system at a first time;
computer-readable program instructions to determine, based on the received first call center data, a first bid for an advertising space associated with an advertising space auction; and
computer-readable program instructions to transmit, to an advertising platform system, the first bid for the advertising space associated with the advertising space auction.

11. The computer program product of claim 10, further comprising:
computer-readable program instructions to receive, from the call center computing system, second call center data describing a second state of the call center computing system at a second time;
computer-readable program instructions to determine, based on the received second call center data, a second bid for an advertising space associated with the advertising space auction, wherein the second bid is different from the first bid; and
computer-readable program instructions to transmit, to an advertising platform system, the second bid for the advertising space associated with the advertising space auction, wherein the second bid replaces the first bid.

12. The computer program product of claim 10, wherein the first call center data comprises one or more of a call center capacity, a call center volume, and an average hold time.

13. The computer program product of claim 10, wherein the call center computing system communicates with one or more telephone computing devices at a location of the call center computing system to determine a status of each of the one or more telephone computing devices at the location and wherein the call center computing system determines the first call center data based at least on the status of each of the one or more telephone computing devices at the call center location.

14. The computer program product of claim 10, further comprising:
computer-readable program instructions to receive, from the advertising platform system, a notice of commencement of the advertising space auction, the notice comprising one or more predefined specifications for advertisements that may be entered into the advertising space auction; and
computer-readable program instructions to determine that the received advertisement conforms to the one or more predefined specifications.

15. The computer program product of claim 14, wherein the one or more predefined specifications comprise one or more of a display size of an advertisement and a duration of an advertisement.

16. A system to bid for advertisements to place in advertising spaces based on current states of call centers associated with the advertisements, comprising:
a storage device; and
a processor communicatively coupled to the storage device, wherein the processor executes application code instructions that are stored in the storage device to cause the system to:
receive, from a call center computing system, first call center data describing a first state of the call center computing system at a first time;
determine, based on the received first call center data, a first bid for an advertising space associated with an advertising space auction; and
transmit, to an advertising platform system, the first bid for the advertising space associated with the advertising space auction.

17. The system of claim 16, wherein the processor is further configured to execute application code instructions stored on the storage device to cause the system to receive an advertisement from a merchant computing system, wherein the first bid for the advertising space is to place the advertisement, and wherein the advertisement comprises a telephone number associated with the call center computing system that the user may dial via a user computing device to initiate a telephone call with the call center computing system.

18. The system of claim 16, wherein the processor is further configured to execute application code instructions stored on the storage device to cause the system to:
receive, from the call center computing system, second call center data describing a second state of the call center computing system at a second time;
determine, based on the received second call center data, a second bid for the advertising space associated with the advertising space auction, wherein the second bid is different from the first bid; and
transmit, to the advertising platform system, the second bid for the advertising space associated with the advertising space auction.

19. The system of claim 16, wherein the first call center data comprises one or more of a call center capacity, a call center volume, and an average hold time.

20. The system of claim 16, wherein the call center computing system communicates with one or more telephone computing devices at a location of the call center computing system to determine a status of each of the one or more telephone computing devices at the location and wherein the call center computing system determines the first call center data based at least on the status of each of the one or more telephone computing devices at the call center location.
